(19) United States
(12) Patent Application Publication
(10) Pub. No.: US 2025/0072404 A1
(43) Pub. Date: Mar. 6, 2025

(54) SUBMERGED ENCLOSURES FOR FISH

(71) Applicant: Subsea Harvest AS, HAUGESUND (NO)

(72) Inventor: Kåre Olav KROGENES, HAUGESUND (NO)

(73) Assignee: Subsea Harvest AS, HAUGESUND (NO)

(21) Appl. No.: 18/728,318

(22) PCT Filed: Feb. 1, 2023
(86) PCT No.: PCT/NO2023/050025

§ 371 Date: Jul. 11, 2024

(30) Foreign Application Priority Data
Feb. 4, 2022 (NO) 20220164

(51) Int. Cl. A01K 61/60; A01K 61/10; A01K 63/04; A01K 63/10

(52) U.S. Cl. CPC A01K 61/60; A01K 63/10; A01K 61/10; A01K 63/047

(57) ABSTRACT

A facility is for farming fish, wherein the facility has a plurality of tight containers arranged to be submerged throughout a growth cycle of the fish. The facility includes a frame structure arranged to hold the containers; a foundation for the frame structure, and the foundation is arranged to rest on a seabed; a plurality of buoyancy bodies arranged to lift at least one portion of the frame structure in a water column; a feed-supply system for feed to the containers; and: a water-supply system for the containers.

### CROSS-REFERENCE TO RELATED APPLICATIONS

This application is the U.S. national stage application of International Application No. PCT/NO2023/050025, filed Feb. 1, 2023, which international application was published on Aug. 10, 2023, as WO 2023/149805 in the English language. The International Application claims priority to Norwegian Patent Application No. 20220164, filed Feb. 4, 2022. The international application and Norwegian application are both incorporated herein by reference, in their entirety.

### FIELD

The invention relates to a facility for farming fish. More particularly, the invention relates to a facility comprising closed containers. The containers rest on a seabed via a frame structure. The fish are farmed in the closed containers, and the container is kept submerged substantially throughout a growth cycle of the fish. The containers may be provided with means that allow each single container to be lifted in a water column independently of the other containers. The facility may be provided with a closed plant for collecting and treating dead fish, uneaten feed, faecal matter and other debris from the containers.

### BACKGROUND

The farming of fish and especially salmonoids has conventionally taken place in cages floating on the water surface. Each cage comprises an enclosure formed of a net. The enclosure is closed in that the fish cannot escape from the enclosure. The enclosure is open in that water can flow through the enclosure. Such cages are relatively simple structures. A drawback is that the fish in the cage are exposed to parasites, such as salmon lice, which come floating with the water. Such cages are exposed to waves and wind and are therefore placed in relatively protected localities along a coastline.

It is known to use closed cages that are floating on the water surface. Such cages are closed in that the wall and the bottom are fluid-proof. Thereby, parasites are prevented from floating in to the fish. Such cages are supplied with fresh, oxygenous water through pipes that take in water at a water depth below where one would expect parasites we to stay. Such closed cages, too, are exposed to waves and wind.

It is also known to use cages that can be lowered completely below the water surface. In that way, the cage is lowered below the waves, and the cage is not that affected by waves and wind. Such cages are formed of nets that surround the entire cage. The cage can be lowered by it being secured to a seabed via a wire or other cable, and by the cage being lowered and lifted in the water column by a winch or its equivalent. Salmonoids are so-called physostomous fish with an open duct between the throat and the swim bladder. If it has been planned for the cage to be submerged for a longer period, it is necessary to arrange an air pocket at the top of the cage for salmonoids to be able to gulp air there. Such a cage is open in that water can flow through the cage. The cage is lowered to a depth at which, assumedly, there are no parasites in the water. Such cages usually have possibilities for collecting dead fish from a central funnel at the bottom of the cage. There are limited possibilities of collecting uneaten feed, faecal matter and other debris. Part of this will move with the water flow out of the cage.

It is also known to farm fish in land-based facilities. Land-based facilities avoid the problems of parasites in the water, bad weather and availability of air for salmonoids. Land-based facilities require large investments and depend on advanced cleaning technology to maintain the water quality of the water that is being recirculated in the facility. Land-based facilities have many and large pumps for moving all the water in the tanks.

### SUMMARY

The invention has for its object to remedy or reduce at least one of the drawbacks of the prior art or at least provide a useful alternative to the prior art.

The object is achieved through the features that are specified in the description below and in the claims that follow.

The invention relates to that facility for farming fish which combines some of the advantages of closed cages and of submersible cages, and without being dependent on water purification, as land-based facilities are.

According to the invention, the facility comprises a plurality of tight containers for farming fish. These containers are submerged in their entirety and are resting on a seabed via a frame structure. The frame structure holds the containers. The containers are supplied with water from the surroundings near the seabed, and this water is free of parasites in the same way as that of closed cages. Another advantage is that the water temperature is more stable through the year compared with surface water. The water is pumped through the containers. The water is not going to be lifted, so this costs little energy. The water is not to be recirculated as in a land-based facility. The water that flows out of the containers may flow into a closed waste-treatment system and be purified there before the water is let into a recipient. In one embodiment, the containers are supplied with air and feed through hoses from shore. In this embodiment, the waste-treatment system may include a hose to shore. It is thereby achieved that the fish-farming takes place in a hidden manner underneath the water surface and is not an obstacle to traffic on the sea.

The invention relates more specifically to a facility for farming fish. The facility comprises a plurality of tight containers arranged to be submerged throughout a growth cycle of the fish. The facility comprises:
a frame structure arranged to hold the containers;
a foundation for the frame structure, and the foundation is arranged to rest on a seabed;
a plurality of buoyancy bodies arranged to lift at least one portion of the frame structure in a water column;
a feed-supply system for feed to the containers; and:
a water-supply system for the containers.

At least one container in an upper portion may be provided with a dome arranged to enclose an air pocket, and the facility includes a gas-supply system connected to the dome. The gas-supply system may be arranged to replenish the air pocket with air or an oxygenous gas as fish in the container consume the air in the air pocket.

The lower portion of the frame structure may form the foundation. The frame structure may rest directly on the seabed. The frame structure may surround the lower portion of the containers and protect this from contact against the seabed.

In one embodiment, the foundation may be connected to a lower portion of a leg. The facility may include a plurality of legs. The frame structure may be displaceably connected to the legs. A portion of the leg may project above a water surface.

In one embodiment, the frame structure may comprise a lower frame structure and an upper frame structure. The lower frame structure and the upper frame structure may be independently displaceable along the legs. At least one container may be adapted for releasable attachment to the upper frame structure and for releasable attachment to the lower frame structure. The container may be releasably attached both to the upper frame structure and the lower frame structure.

The buoyancy bodies may be arranged to lift the frame structure in the water column so that the upper portion of the containers projects above a water surface. The buoyancy bodies may be arranged to lift the upper frame structure in the water column so that the upper portion of the containers projects above the water surface. This has the advantage of it being possible to access the containers from a boat and work on the containers without using diving equipment.

The facility may include a waste-treatment system. The waste-treatment system comprises a main drain from an outlet at the bottom of the container. This has the advantage of the facility collecting all the discharge from the containers and carrying it to treatment plants. Both particulate and dissolved waste can be treated as the waste-treatment system is a closed plant.

### BRIEF DESCRIPTION OF THE DRAWINGS

In what follows, examples of preferred embodiments are described, which are visualized in the accompanying drawings, in which:

FIG. 1 shows a perspective view of a facility for farming fish in accordance with the invention;

FIG. 2 shows a side view of the facility shown in FIG. 1;

FIG. 3 shows a side view, on the same scale as FIG. 2, of a facility for farming fish in an alternative embodiment;

FIG. 4 shows the same as FIG. 3, but some of the containers for farming fish are in a lifted position;

FIG. 5 shows a top view, on a larger scale, of the facility shown in FIG. 2;

FIGS. 6-7 show a side view and a top view, respectively, of a facility as shown in FIG. 1, but in an embodiment in which the facility is connected to a land station;

FIGS. 8-9 show a side view and a top view, respectively, of a facility in an alternative embodiment in which the facility is connected to a land station;

FIGS. 10-12 show two side views of a long side and a short side and a top view, respectively, of the facility shown in FIG. 8, but in an alternative embodiment in which the facility is connected to a raft.

### DETAILED DESCRIPTION OF THE DRAWINGS

All positional indications refer to the position shown in the figures.

In the figures, the same or corresponding elements are indicated by the same reference number. For the sake of clarity, some elements may be without reference numbers in some figures.

A person skilled in the art will appreciate that the figures are only principle drawings. The relative proportions of individual elements may also be distorted.

In the figures, the reference numeral 1 indicates a facility for farming fish. The facility 1 comprises a plurality of tight containers 2 and a frame structure 3 which is arranged to hold the containers 2. The facility 1 also comprises a foundation 4 which is arranged to rest on a seabed 9. The frame structure 3 is provided with a plurality of buoyancy bodies 33. The buoyancy bodies 33 are arranged to lift or lower at least one portion 31 of the frame structure 3 in a water column 90. The facility 1 includes a water-supply system 5 and a feed-supply system 6.

In some embodiments, the facility 1 may include a waste-treatment system 7. In some embodiments, the facility 1 may include a gas-supply system 8.

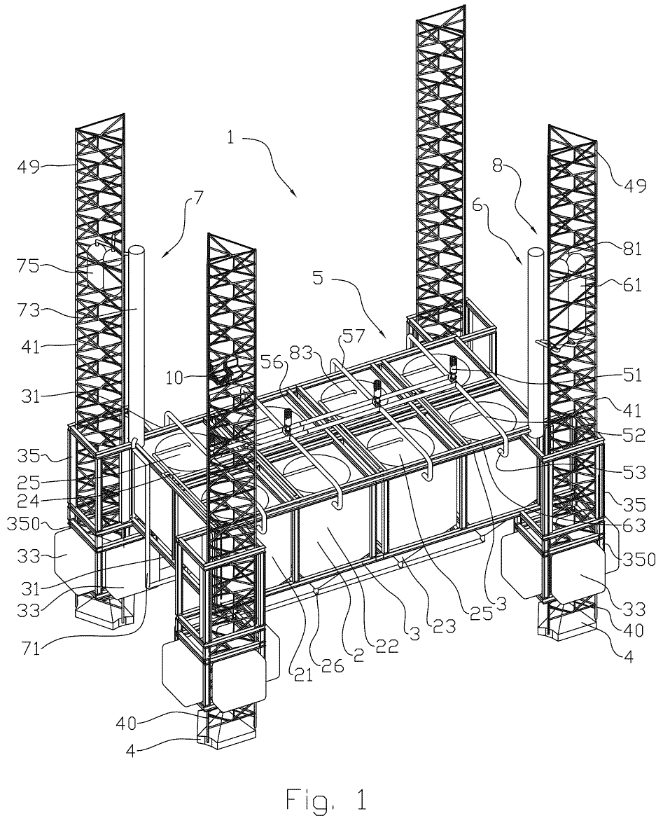

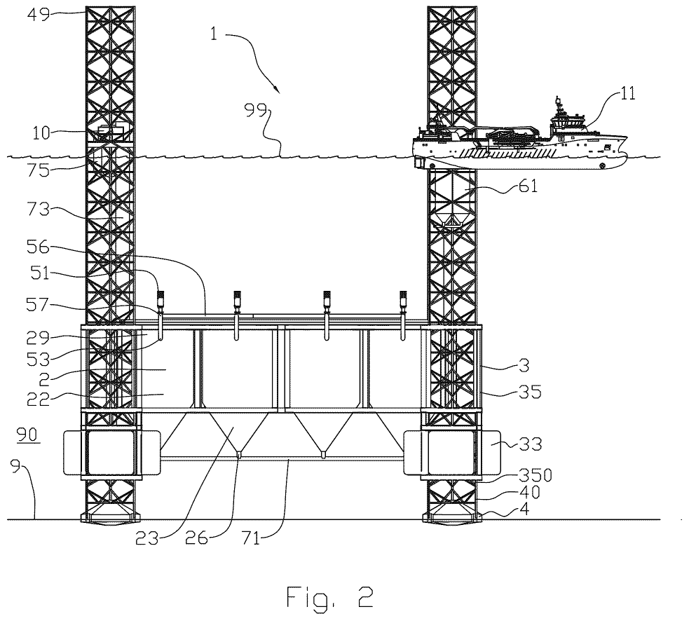

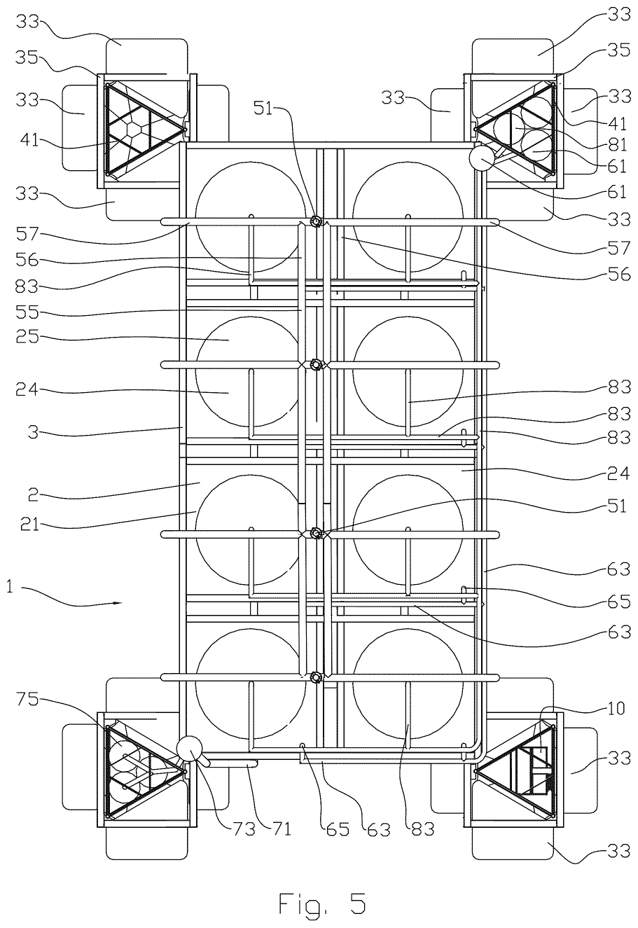

A first embodiment of the invention is shown in FIGS. 1 and 2. The facility 1 is shown with eight tight containers 2 which are attached to the frame structure 3. Viewed from above, the frame structure 3 is shaped like a rectangle, as shown in FIG. 5. At each corner, the frame structure 3 is provided with a guide 35 attached to the frame structure 3. The guide 35 surrounds a leg 41. The leg 41 is connected, in its lower portion 40, to the foundation 4, and the foundation 4 rests on the seabed 9, as shown in FIG. 2. The leg 41 is shown as a latticework structure with a triangular cross section, see FIG. 5. In alternative embodiments, the leg 41 may be formed as a latticework structure with a rectangular cross section, like a pillar or like a pylon. The frame structure 3 with the guides 35 is arranged to be displaced upwards and downwards along the leg 41. The frame structure 3 and/or the guides 35 are provided with a locking mechanism (not shown) locking the frame structure 3 to the leg 41 at the desired depth.

The buoyancy bodies 33 are shown in one embodiment in FIGS. 1 and 2. The buoyancy bodies 33 are attached to the guides 35 in the lower portion 350 of the guides 35. The buoyancy bodies 33 may have a fixed positive buoyancy. The buoyancy bodies 33 may have a variable positive buoyancy. The buoyancy bodies 33 may be arranged to be filled with ballast, such as seawater, and to be filled with a gas, such as air. Some of the buoyancy bodies 33 may be arranged to have fixed buoyancy, and some of the buoyancy bodies 33 may be arranged to be filled with ballast or with gas.

The leg 41 may be so long that an upper portion 49 projects above a water surface 99, as shown in FIGS. 2-4.

In the figures, the containers 2 are shown as containers 2 with a square cross section, viewed from above, see FIG. 5 in particular. In alternative embodiments, the containers 2 may be formed with a circular cross section or a rectangular cross section (not shown). The cross section may also be shaped like a polygon, such as a hexagon or an octahedron (not shown). The containers 2 are shown as fluid-proof containers 21 with fluid-proof walls 22. The container 2 is provided with a cone-shaped bottom 23 and a tight roof 24. A central portion of the roof 24 is formed with a dome 25.

An operating centre 10 is shown placed inside one of the legs 41 and above the water surface 99. The operating centre 10 may comprise a control module, a dwell module and a power-supply module such as an aggregate for producing electrical energy.

The water-supply system 5 comprises an at least one pump 51. The pump 51 takes in water from the water column 90. On its delivery side, the pump 51 is connected to a water distributor 52. The water distributor 52 is provided with an inlet 53 for each container 2. The inlet 53 is advantageously positioned in the upper portion 29 of the container 2 or in the roof 24. The water flows out of the container 2 through an outlet 26 in the bottom 23. The water distributor 51 comprises a plurality of pipes 55 which together form a stem 56 and branches 57, se FIG. 5 in particular. To ensure a supply of water to each container 2, the stem 56 is divided into two.

The feed-supply system 6 comprises one or more feed silos 61. The feed silos 61 are shown placed inside one of the legs 41. A vessel 11, as shown in FIG. 2, may supply the feed silos 61 in a known manner. (There will be more here.) The feed-supply system 6 includes a feed line 63. Each container 2 is provided with a feed inlet 65 in the roof 24 so that each container 2 is supplied with feed through the feed line 63. The feed is distributed inside the container 2 in at least one feed spreader (not shown).

Each container 2 is connected in a fluid-proof manner to the waste-treatment system 7 via the outlet 26 at the bottom 23. The outlet 26 discharges into a fluid-proof main drain 71 as shown in FIGS. 2-4. The main drain 71 is arranged to carry water, faecal matter, feed residues, other debris and dead fish to a treatment tank 73. The treatment tank 71 is shown on the outside of an of the legs 41. Treated waste flows from the treatment tank 73 to one or more storage tanks 75. The storage tanks 75 are shown placed inside one of the leg 41. A vessel (not shown) can empty the storage tanks 75 of contents. The water-supply system 5 will create an overpressure in each container 2. The overpressure will make water, faecal matter, feed residues and other debris flow through the main drain 71 to the treatment tank 71.

The gas-supply system 8 comprises one or more gas tanks 81. The gas tank 81 is shown placed inside one of the legs 41. A vessel 11, as shown in FIG. 2, may supply the gas tank 81 with gas in a known manner. The gas may be an oxygenous gas. The gas-supply system 8 comprises a gas line 83. The gas line 83 is connected in a gas-proof manner to the gas tank 83. The gas line 83 is branched and supplies each dome 25 with gas. In an alternative embodiment, the gas-supply system 8 includes a compressor (not shown) which takes in air from the surroundings, and the compressor supplies each dome 25 with air via the gas line 83.

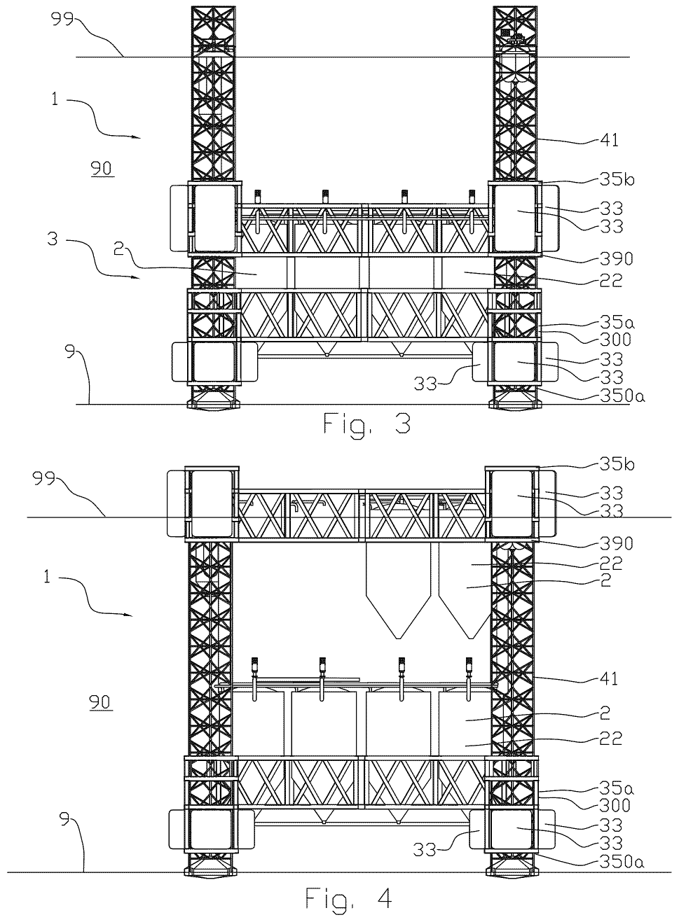

A second embodiment of the invention is shown in FIGS. 3 and 4. The facility 1 is shown with eight tight containers 2 which are attached to the frame structure 3. Viewed from above, the frame structure 3 is formed like a rectangle as shown in FIG. 5. For the sake of exposure, the reference numerals of most of the technical features that is identical of the embodiment according to FIGS. 1 and 2 have been left out. The frame structure 3 is divided into a lower frame structure 300 and an upper frame structure 390. The lower frame structure 300 is provided, at every corner, with a guide 35a attached to the frame structure 300. The guide 35a surrounds the leg 41. The upper frame structure 390 is provided, at each corner, with a guide 35b attached to the frame structure 300. The guide 35b surrounds the leg 41. The lower frame structure 300 with the guides 35a is arranged to be displaced upwards and downwards along the leg 41. The upper frame structure 390 with the guides 35b is arranged to be displaced upwards and downwards along the leg 41. The lower frame structure 300 and/or the guides 35a are provided with a locking mechanism (not shown) which locks the lower frame structure 300 to the leg 41 at the desired depth. The upper frame structure 390 and/or the guides 35b are provided with a locking mechanism (not shown) which locks the upper frame structure 390 to the leg 41 at the desired depth.

Buoyancy bodies 33 are attached to the guides 35a in the lower portion 350a of the guides 35a. The buoyancy bodies 33 may have a fixed positive buoyancy. The buoyancy bodies 33 may have a variable positive buoyancy. The buoyancy bodies 33 may be arranged to be filled with ballast, such as seawater, and to be filled with a gas, such as air. Some of the buoyancy bodies 33 may be arranged to have fixed buoyancy, and some of the buoyancy bodies 33 may be arranged to be filled with ballast or with gas. Buoyancy bodies 33 are attached to the guides 35b.

The lower frame structure 300 is arranged to be releasably connected to each container 2. The upper frame structure 390 is arranged to be releasably connected to each container 2. Each container 2 is arranged to selectably be releasably attached to the lower frame structure 300, to the upper frame structure 390 or to both the lower frame structure 300 and the upper frame structure 390. The branch 57 of the water-supply system 5, the feed line 63, the outlet 26 to the main drain 71 and the gas line 83 are all arranged with couplings (not shown) for each container 2, so that the container 2 can be displaced vertically. The couplings are arranged to seal when the coupling is disconnected. The couplings are arranged to be connected or disconnected when one part of the coupling is displaced vertically relative to another part of the coupling.

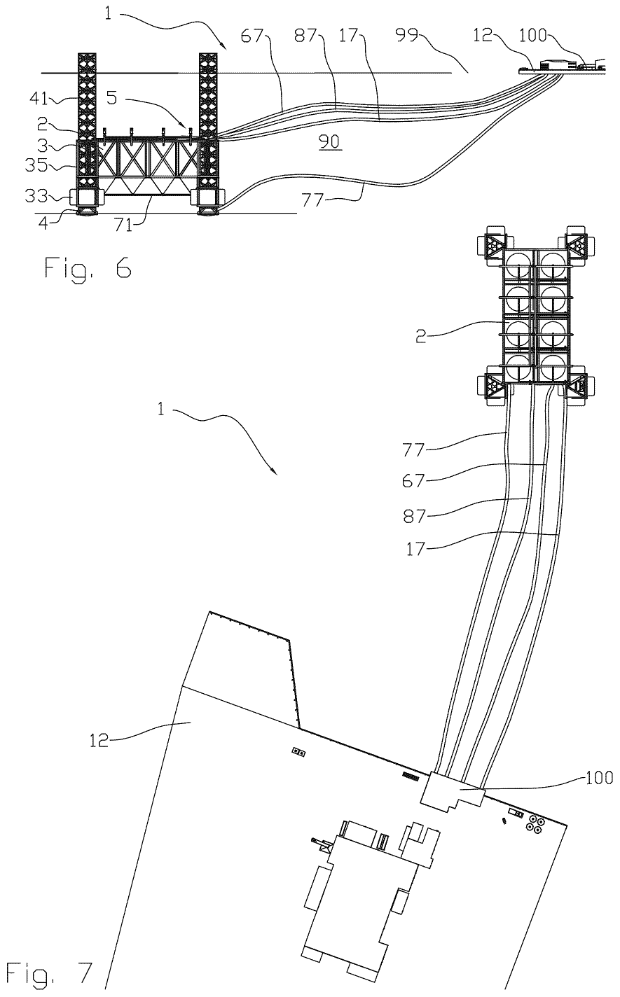

A third embodiment of the facility 1 is shown in FIGS. 6 and 7. The facility 1 of this third embodiment comprises containers 2, a frame structure 3 with guides 35, buoyancy bodies 33, legs 41 and a water-supply system 5 as described for the first embodiment. The facility 1 includes an operating centre 100 on shore 12, providing the facility 1 with feed and gas. The operating centre 100 receives waste from the facility 1.

The feed-supply system 6 comprises feed silos (not shown) on shore 12, a mixing system for feed and water and a feed-supply line 67 from the mixing system to the facility 1. The feed-supply line 67 is connected to the feed line 63 at the facility 1.

The waste-treatment system 7 comprises tanks (not shown) on shore 12 for receiving water, faecal matter, feed residues and other debris from the facility 1. The waste-treatment system 7 comprises a drainpipe 77 from the facility 1 to shore 12. The drainpipe 77 is connected to the main drain 71 at the facility 1.

The gas-supply system 8 comprises gas tanks (not shown) on shore 12. The gas-supply system 8 comprises a gas pipe 87 from shore 12 to the facility 1. The gas pipe 87 is connected to the gas line 83 at the facility 1. In an alternative embodiment, the gas-supply system 8 includes a compressor (not shown) that takes in air from the surroundings, and the compressor supplies the gas pipe 87 with compressed air.

The facility 1 is supplied with electrical energy through a cable 17 from shore 12. The cable 17 comprises conductors for electrical energy, signal cables for transmitting control signals to the facility 1 and signal cables for receiving signals from sensors (not shown) at the facility 1.

A fourth embodiment of the facility 1 is not shown. The facility 1 of this fourth embodiment comprises containers 2, a lower frame structure 300 with guides 35a, an upper frame structure 390 with guides 35b, buoyancy bodies 33, legs 41 and a water-supply system 5 as described for the second embodiment. The fourth embodiment comprises an operating centre 100 on shore 12 as described for the third embodiment. the operating centre provides the facility 1 with feed and gas. The operating centre 100 receives waste from the facility 1. The facility 1 includes a feed-supply line 67, a drainpipe 77, a gas pipe 87 and a cable 17 as described for the third embodiment.

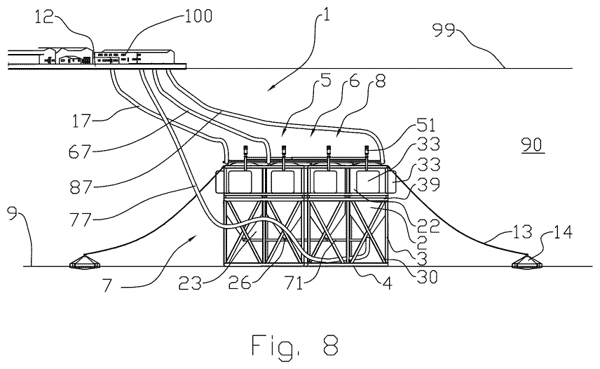

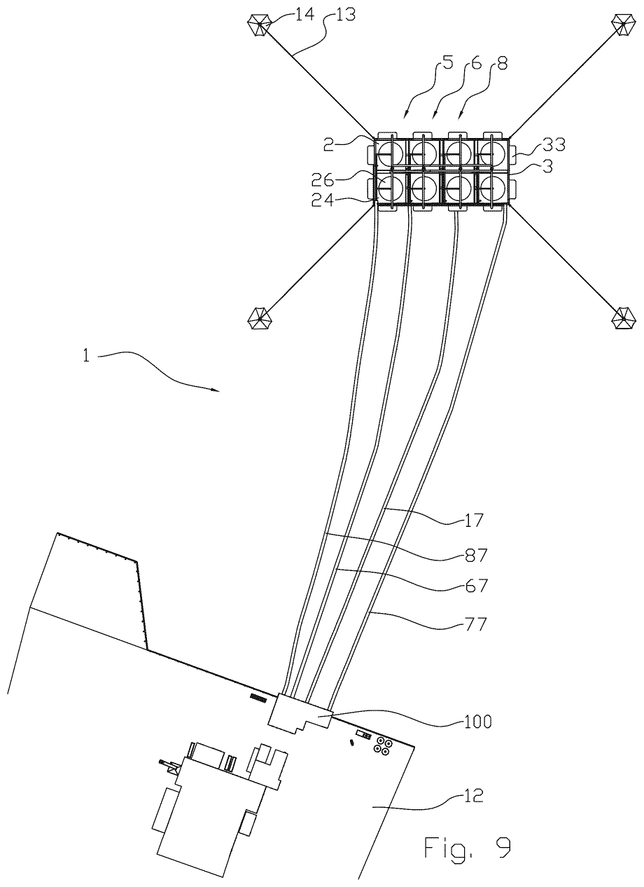

A fifth embodiment of the facility 1 is shown in FIGS. 8 and 9. The facility 1 of this fifth embodiment comprises a frame structure 3 resting in an anchored manner on the seabed 9. The lower portion 30 of the frame structure 3 surrounds the conical bottom 23 of the container 2, the outlet 26 and the main drain 71. In this embodiment, the lower portion 30 forms the foundation 4 of the facility 1. The facility 1 comprises a plurality of anchor lines 13 which are attached, in a first end portion, to the frame structure 3 and are attached, in an opposite second end portion, to an anchor 14.

The frame structure 3 is provided with buoyancy bodies 33. The buoyancy bodies 33 are attached to an upper portion 39 of the frame structure 3. The buoyancy bodies 33 may have a fixed positive buoyancy. The buoyancy bodies 33 may have a variable positive buoyancy. The buoyancy bodies 33 may be arranged to be filled with ballast, such as seawater, and to be filled with a gas, such as air. Some of the buoyancy bodies 33 may be arranged to have fixed buoyancy, and some of the buoyancy bodies 33 may be arranged to be filled with ballast or with gas.

The water-supply system 5 comprises a at least one pump 51. The pump 51 takes in water from the water column 90. The water-supply system 5 is formed in the same way as described for the first embodiment and comprises a water distributor 52, an inlet 53 for each container 2, a plurality of pipes 55 and an outlet 26 at the bottom 23.

The feed-supply system 6 comprises a feed line 63 at the facility 1 as described for the first embodiment. The feed-supply system 6 comprises feed silos (not shown) on shore 12, a mixing system for feed and water and a feed-supply line 67 from the mixing system to the facility 1. The feed-supply line 67 is connected to the feed line 63 at the facility 1.

The waste-treatment system 7 comprises tanks (not shown) on shore 12 for receiving water, faecal matter, feed residues and other debris from the facility 1. The waste-treatment system 7 comprises a drainpipe 77 from the facility 1 to shore 12. The drainpipe 77 is connected to the main drain 71 at the facility 1.

The gas-supply system 8 comprises gas tanks (not shown) on shore 12. The gas-supply system 8 comprises a gas pipe 87 from shore 12 to the facility 1. The gas pipe 87 is connected to the gas line 83 at the facility 1 as described for the first embodiment. In an alternative embodiment, the gas-supply system 8 includes a compressor (not shown) that takes in air from the surroundings, and the compressor supplies the gas pipe 87 with compressed air.

The facility 1 is supplied with electrical energy from shore 12 through a cable 17. The cable 17 comprises conductors for electrical energy, signal cables for transmitting control signals to the facility 1 and signal cables for receiving signals from sensors (not shown) at the facility 1.

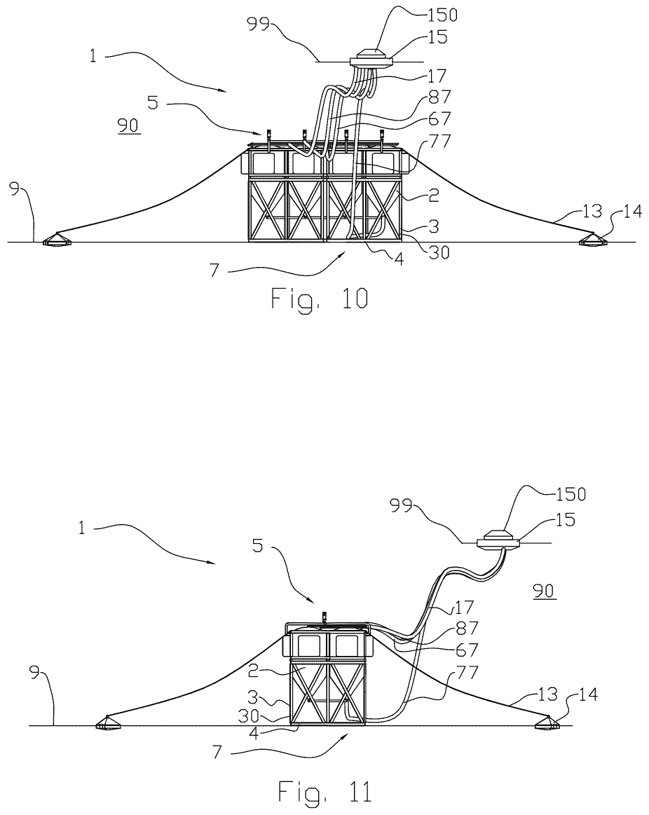

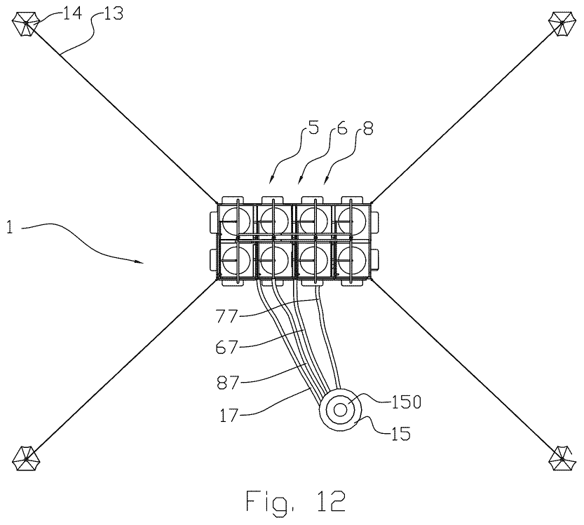

A sixth embodiment of the facility 1 is sown in FIGS. 10-12. In this sixth embodiment, the facility 1 comprises a frame structure 3 resting in an anchored manner on the seabed 9, as described for the fifth embodiment. The facility 1 comprises a plurality of anchor lines 13 which are attached, in a first end portion, to the frame structure 3 and are attached, in an opposite second end portion, to an anchor 14. The facility 1 comprises containers 2 and a frame structure 3 as described for the fifth embodiment.

In the sixth embodiment, the facility 1 includes a raft 15. The raft 15 includes an operating centre 150. The raft 15 also includes feed silos (not shown), a mixing system for feed and water (not shown) as part of the feed-distribution system 6, gas tanks (not shown) as part of the gas-distribution system 8, and tanks (not shown) for receiving water, faecal matter, feed residues and other debris from the facility 1 as part of the waste-treatment system 7. The barge 15 is anchored to the seabed 9 with an anchoring system (not shown).

The feed-supply system 6 comprises a feed line 63 at the facility 1, as described for the first embodiment. A feed-supply line 67 connects the mixing system and the feed line 63.

The waste-treatment system 7 comprises tanks (not shown) on the raft 15 for receiving water, faecal matter, feed residues and other debris from the facility 1. The waste-treatment system 7 comprises a drainpipe 77 from the facility 1 to the raft 15. The drainpipe 77 is connected to the main drain 71 at the facility 1.

The gas-supply system 8 comprises a gas pipe 87 from the raft 15 to the gas line 83 at the facility 1 as described for the first embodiment. In an alternative embodiment, the gas-supply system 8 includes a compressor (not shown) which takes in air from the surroundings, and the compressor supplies the gas pipe 87 with compressed air.

The facility 1 may be supplied with electrical energy from shore 12 through an energy cable (not shown). The facility may be provided with electrical energy from an aggregate (not shown) on the raft 15. A cable 17 comprises conductors for electrical energy, signal cables for transmitting control signals to the facility 1 from the operating station 150, and signal cables for receiving signals from sensors (not shown) at the facility 1.

The facility 1 is a closed facility for farming fish. The containers 2 are fluid-proof containers 21. The containers 2 are submerged in water and filled with water so that there is no pressure difference between the inside and the outside of the container 2. The walls 22, bottom 23 and roof 24 may therefore be formed of thin plates in metal, a polymer or a composite material. The facility 1 is arranged to be submerged from the fish (not shown) are put into the container 2 until the fish are removed from the container 2. Salmonoids are physostomous fish and need to fill the swim bladder with air. The container 2 is therefore provided with an air-filled or gas-filled dome 25 in the roof 24. The fish in the container 2 may fill the swim bladder with air or gas from the dome 25. The dome 25 is supplied with gas or air from the gas-supply system 8.

The water in the container 2 is replaced by oxygen-rich water from the surroundings being pumped into the container via the water-supply system 5. The water flows out of the outlet 26 at the bottom 23 into a fluid-proof main drain 71. The water will carry faecal matter, feed residues, other debris and dead fish. The waste-treatment system 7 is arranged to purify the water before it is discharged into a recipient. The waste-treatment system may include screens, filters, sedimentation tanks, and other equipment as is known from the purifying of wastewater. Since the facility 1 is closed, all the wastewater from the facility 1 may be purified.

The fish in the containers 2 are fed a known fish feed (not shown). The fish feed is stored in feed silos in a known manner. From the feed silo, the feed is carried to a mixing apparatus in which the feed is mixed with water in order then to be pumped in the feed-supply system 5 up to the container 2 in a manner known per se. The feed is distributed inside the container 2 through one or more feed-spreaders for waterborne feed.

The frame structure 3 is arranged to be lifted and lowered in the water column 90 by means of the buoyancy bodies 33. The frame structure 3 of the exemplary embodiments one to four may be lifted and/or lowered along the legs 41 after the locking mechanism has been released. The frame structure 3 of the fifth and sixth exemplary embodiments may be lifted and lowered with providing each anchor line 13 with a ballast weight (not shown) between the frame structure 3 and the anchor 14. When the frame structure 3 with the containers 2 is to be lowered, the ballast weights are filled with water and the buoyancy of the buoyancy bodies 33 is adjusted in such a way that the buoyancy will be negative. In a corresponding manner, the ballast weights are filled with air and the buoyancy of the buoyancy bodies 33 is adjusted, so that the buoyancy will be positive when the frame structure 3 with the containers 2 is to be lifted.

The frame structure 3 may be lifted in the water column 90 so that the upper portion 29 of the container 2 projects above the water surface 99. Fish may be put into the containers 2 through hatches (not shown) in the roof 24 or through hatches in the wall 22. Fish may also be pumped out of the containers 2 through the hatches, not shown, in the roof 24 or in the wall 22.

The facility 1 makes it possible to farm fish, such as salmonoids, in a closed and submerged system from the release into the container 2 until the fish have grown to slaughter size. There is no need to lift the containers 2 to the water surface 99 during the growth period.

The frame structure 3 and the containers 2 are lowered so deep that the water inlets of the pumps 51 get deep enough for the entry of parasites and algae into the containers 2 to be avoided.

It should be noted that all the above-mentioned embodiments illustrate the invention, but do not limit it, and persons skilled in the art may construct many alternative embodiments without departing from the scope of the attached claims. In the claims, reference numbers in brackets are not to be regarded as restrictive.

The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1. A facility for farming fish, the facility comprising a plurality of tight containers arranged to be submerged throughout a growth cycle of the fish, the facility comprising:
a frame structure arranged to hold the containers;
a foundation for the frame structure, and the foundation is arranged to rest on a seabed;
a plurality of buoyancy bodies arranged to lift at least one portion of the frame structure in a water column ;
a feed-supply system for feed to the containers; and
a water-supply system for the containers.

2. The facility in accordance with claim 1, wherein at least one container in an upper portion is provided with a dome arranged to enclose an air pocket, and the facility includes a gas-supply system connected to the dome.

3. The facility in accordance with claim 1, wherein the lower portion of the frame structure forms the foundation.

4. The facility in accordance with claim 1, wherein the foundation is connected to a lower portion of a leg, the facility comprises a plurality of legs , and the frame structure is displaceably connected to the legs.

5. The facility in accordance with claim 4, wherein an upper portion of the leg projects above a water surface.

6. The facility in accordance with claim 4, wherein the frame structure comprises a lower frame structure and an upper frame structure.

7. The facility in accordance with claim 6, the lower frame structure and the upper frame structure are independently displaceable along the legs.

8. The facility in accordance with claim 7, wherein at least one container is adapted for releasable attachment to the upper frame structure and for releasable attachment to the lower frame structure.

9. The facility in accordance with claim 1, wherein the buoyancy bodies are arranged to lift the frame structure in the water column, so that the upper portion of the containers projects above a water surface.

10. The facility in accordance with claim 9, wherein the buoyancy bodies are arranged to lift the frame structure in the water column so that the upper portion of the containers projects above the water surface.

11. The facility in accordance with claim 1, wherein the facility comprises a waste-treatment system.

12. The facility in accordance with claim 11, wherein the waste-treatment system comprises a main drain from an outlet at the bottom of the container.

13. The facility in accordance with claim 2, wherein the foundation is connected to a lower portion of a leg, the facility comprises a plurality of legs, and the frame structure is displaceably connected to the legs.
